(19) United States
(12) Patent Application Publication
(10) Pub. No.: US 2023/0256696 A1
(43) Pub. Date: Aug. 17, 2023

(54) Multi-Platen Press

(71) Applicant: Dylan Towers, Moorpark, CA (US)

(72) Inventor: Dylan Towers, Moorpark, CA (US)

(21) Appl. No.: 18/168,566

(22) Filed: Feb. 13, 2023

Related U.S. Application Data
(60) Provisional application No. 63/267,895, filed on Feb. 11, 2022.
(60) Provisional application No. 63/363,369, filed on Apr. 21, 2022.

(51) Int. Cl. B30B 9/10; B30B 15/06; B30B 15/04

(52) U.S. Cl. CPC B30B 9/10; B30B 15/064; B30B 15/04

(57) ABSTRACT

The present invention pertains in general to a multi-platen press apparatus and method for compressing and extracting fluids, rosin, and oils from plants and plant materials. The apparatus and method provides for simultaneous platen gap closure, support for a taller internal frame, higher quantities of fluids, rosin, and oils from plants and plant materials during a single cycle, a more uniform heat and pressure distribution between each platen, greater control in accommodating flow rates of different materials based on setting and locking the internal frame at different angles during operation, greater control and easier rotation from a vertical to a horizontal position.

### CROSS REFERENCE TO RELATED APPLICATIONS

This application claims benefit to provisional patent application No. 63/267,895, entitled “Multi-Plate Rosin Press”, filed Feb. 11, 2022; and provisional patent application No. 63/363,369, entitled “Multi-Platen Rosin Press”, filed Apr. 21, 2022; the entire contents of which are incorporated by reference in their entirety for all purposes.

### FIELD OF THE INVENTION

The present invention pertains in general to an apparatus and method for compressing and extracting fluids, rosin, and oils from plants and plant materials.

### BACKGROUND OF THE INVENTION

Plant material commonly provides an important source material for extraction of compounds which are used in oils, medicinals, aromatherapy, cuisine, perfumes, dyes, oils, tinctures, distillation products and the like. The extraction of the compounds from plant material involves the extraction of compounds from different parts of a plant such as flowers, buds, and leaves harvested from plants (e.g., plant material). Typically, the plant material is processed to extract desired compounds or components. In certain extraction processes, plant matter is compressed and heated to extract oils and/or rosin. In certain extraction processes, the plant material comprises that of cannabis.

The extraction of oils or rosins during a compression process has previously been a labor-intensive process. Use of modern techniques and equipment has simplified and created efficiencies surrounding the processes of pressing and heating plant material to extract compounds. Typically, plant material is compressed between heated compression plates of a press. Extracts pressed out of the compressed plant material then accumulate on the compression plates of the press. Once the press is opened and the plant material is removed, the extracts must then be scraped from the surface of the press.

There exists an identified need for extraction systems that improve upon and advance the design of known systems. Further, there exists a need for extraction methods that address the shortcomings of the conventional extraction systems and methodologies described herein. Examples of new and useful extraction systems relevant to the needs existing in the field are discussed below.

### SUMMARY OF THE INVENTION

The present invention surrounds an apparatus and method for compressing and extracting fluids, rosin, and oils from plants and plant materials. Embodiments of the present invention as disclosed provide an extraction method and apparatus for compressing and extracting fluids, rosin, and oils from plants and plant materials.

Known press and extraction systems are not entirely satisfactory for the range of applications in which they are employed. Some press apparatuses exist, such as U.S. Pat. No. 10,688,746 (“the '746 Patent”) to Perez et al. and U.S. Pat. No. 10,882,266 (“the '266 Patent”) to Britton, the entire contents of which are incorporated herein by reference in their entirety by reference for all purposes. The'746 Patent discloses a rosin press used for extracting fluids, oils, and rosins from plant-based materials. The '746 patent relies on the use of a rotary coupling which is centrally located in relation to the press. The press of the '746 patent consists of moveable platens and a static platen wherein the moveable platens are pressed against the static platen to build pressure between the platens. A user grasps and pulls a handle to rotate the press from a vertical orientation to a horizontal orientation in order to allow the extracted compounds to flow out and downward to a collection area located directly below the press. The invention as taught by the '746 patent is lacking in multiple capacities. The use of a static platen reduces the functionality of the press as heat energy is lost to the unheated portions of the press, wherein the non-heated portions of the press act as heat-sinks and result in parasitic heat loss away from the plant material between the platens. Further, the centrally located rotary coupling results in the collection plate being required to be located directly below the press in a vertical or horizontal orientation, thus adding to the overall height of the press and limiting the amount of material which can be pressed within a given height envelope. It will be appreciated that the collection plate located directly below the press results in the loading and unloading of the press between processes to impede with the clearing of material from the collection plate between extraction processes.

It is an aspect of the present invention to provide a press wherein the pivotal connection between the frame of the apparatus and the stand is offset from the central aspect of the frame wherein the rotation of the frame from a vertical orientation to a horizontal orientation results in the platens to be disposed outward and away from the pivotal interconnection. Thus, the collection plate of the present invention is offset outward to allow for simultaneous unloading/reloading of the platens and removal of the extract from the previous cycle and the preparation of the collection plate for the following cycle.

Further still, the '746 patent uses a passive restraint system for maintaining the press in a desired configuration and requires pulling or pushing on a handle, which can lead to inadvertent and undesired changes of the position of the press. The '746 patent describes the use of spring plungers and ball joint systems. It is an aspect of the present invention to provide a positive constraint system for maintaining the frame of the press in a desired orientation. In certain embodiments, a brake system is used as a positive constraint system wherein the brake is in a holding configuration by default and allows rotation of the frame only when a brake release lever is actuated and a handle is manipulated to pull or push the frame into a desired orientation.

It is a further aspect of the present invention to provide a rotational assist device that is interconnected between the stand and the frame wherein the rotational assist device is configured to reduce or eliminate forces required to rotate the frame following the actuation of the brake release.

The '746 Patent and the '266 Patent each provide solutions only capable of sequential closing of gaps between platens wherein a piston is actuated to close the gap between a first and second platen, prior to the closing of a gap between a second and third platen. Such a strategy is problematic due to the need to fully apply pressure across all platens prior to being able to rotate the press from drainage. It is an aspect of the present invention to allow the simultaneous closure of gaps between platens and thereby allowing for the simultaneous building of equal amounts of pressure between platens. In certain embodiments, springs are placed between the platens, wherein the springs comprise equal spring rates, thereby allowing for the closure of gaps between platens at a consistent rate across the entirety of the press. This further allows the equal building of pressure across all platens, thereby allowing for the closure of all gaps prior to building of pressure. Thus, in certain embodiments as desired, a user may operate the press to close all gaps thereby holding all material in place, then rotate the frame prior to building pressure and extracting compounds. While springs are described herein, the use of any element which acts as a spring and comprises a linear spring rate or progressive spring rate are within the spirit and scope of the present invention.

It is an aspect of the present invention to provide for simultaneous platen gap closure, support for a taller internal frame, higher quantities of fluids, rosin, and oils from plants and plant materials during a single cycle, a more uniform heat and pressure distribution between each platen, greater control in accommodating flow rates of different materials based on setting and locking the internal frame at different angles during operation, greater control and easier rotation from a vertical to a horizontal position.

In certain embodiments, the present invention comprises multiple platens that are hydraulically driven to compress plant or plant materials. While hydraulic power is described herein, alternate forms of linear actuation such as electric actuators, pneumatic actuators, and electropneumatic actuators are within the spirit and scope of the present invention. Furthermore, embodiments comprising a single linear actuator configured to drive the multiple platens, and embodiments comprising multiple linear actuators configured to drive the multiple platens are within the spirt and scope of the present invention.

In certain embodiments, the platens are electrically heated. However, alternate forms of heating the platens are within the spirit and scope of the present invention.

The plant or plant materials contain fluids, rosin, and oils that are collected after compression. In certain embodiments the frame of a multi-platen press is rotatively coupled to a stand such that the frame moves between a vertical and horizontal position, as well as capabilities of locking in various angles between. Springs are located between each set of platens to allow consistent and simultaneous application of pressure to each platen set and plant and plant materials.

In certain embodiments, the press contains several additional features besides that of pressing plant or plant materials, including but not limited to, lights, automation, visual display, touchpad display, safety windows, collection systems, cooled collection plates, hand brake for rotation locking and movement, wireless connectivity, and computer connectivity capabilities.

Certain embodiments of the present invention provide: a frame with an open front aspect thereby allowing the loading and unloading of plant material between the multiple platens.

In certain embodiments, the frame comprises a pivotal interconnection with a stand. The pivotal interconnection allows the rotation of the frame in relation to the stand to allow the loading, extracting, and unloading of the press. In certain embodiments the frame is configured to rotate between a vertical orientation for loading and unloading, and a horizontal orientation to allow the draining of the extracted compounds onto a collection plate. In certain embodiments, the pivotal interconnection is offset towards one end of the frame. In certain embodiments, the frame comprises linear guides connected to an internal aspect of the frame.

Certain embodiments of the present invention have platens slidably connected to the linear guides of the frame, where the platens are configured to compress material between the platens. In some embodiments, the platens have a heating element. In some embodiments, the platens have a temperature sensing device such as a thermocouple, or thermistor, however the temperature sensing device is not limited thereto.

Certain embodiments of the present invention have springs positioned between the platens, the springs being configured to apply an expanding force between the platens.

Certain embodiments of the present invention have a linear actuator interconnected to the frame, wherein the linear actuator is configured to translate longitudinally within the frame and translate the platens towards one end of the frame and thereby compressing the platens toward one another. In certain embodiments, the linear actuator comprises a top plate for distributing the applied force equally over the surface area of a platen surface which the linear actuator applies force to.

Certain embodiments of the present invention have a stationary structure interconnected within the frame configured to arrest the translation of the platens towards the frame. In some embodiments, the stationary structure is compressible such as a spring, compressible bushing, or other compressible element. In some embodiments, the stationary structure comprises a compressible bushing. In some embodiments, the stationary structure comprises a first insulator plate that abuts a second insulator plate that is attached to the platens. In certain embodiments, the insulator plates are configured to abut one another when the platens are translated toward the first end of the frame. The insulator plates are adapted to mitigate transferring of heat energy between the platens and the frame.

Certain embodiments of the present invention comprise a collection plate located below the platens when the frame is moved away from a vertical orientation. In some embodiments, the collection plate comprises a cooling element.

Certain embodiments of the present invention comprise a brake interconnected between the stand and the frame. In some embodiments, the brake is configured to restrict the rotation of the frame in relation to the stand. In some embodiments, the brake comprises a brake release that when actuated, allows the rotation of the frame in relation to the stand about the pivotal connection and the release of the brake release results in restricting the rotation of the frame in relation to the stand. Alternately, embodiments wherein the brake is configured to be in a released configuration until the brake is actuated are within the spirit and scope of the present invention.

Certain embodiments of the present invention comprise a rotational assist device that is interconnected between the stand and the frame. In some embodiments, the rotational assist device is adapted to provide counterbalancing support for rotating the frame about the pivotal interconnection thereby reducing or eliminating the force required to rotate the frame in relation to the stand. In some embodiments, the rotational assist device comprises a linear actuator. In some embodiments, the linear actuator is a gas strut. Alternate embodiments wherein the rotational assist device comprises a rotary spring, a rotary motor, or other mechanical assist device are within the spirit and scope of the present invention.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should be construed as being representative of the full extent and scope of the present invention. The present invention is set forth in various levels of detail in this Summary, as well as in the attached drawings in the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings and the exemplary claims provided herein.

### BRIEF DESCRIPTION OF THE DRAWINGS

A complete understanding of the present invention may be obtained by reference to the accompanying drawings, when considered in conjunction with the subsequent detailed description, in which:

FIG. 1 is a front perspective view of certain embodiments of a multi-platen press.

FIG. 2 is a front view of certain embodiments of a multi-platen press.

FIG. 3A is a side view of certain embodiments of a multi-platen press wherein the frame is in a vertical orientation.

FIG. 3B is a side view of certain embodiments of a multi-platen press wherein the frame is in an orientation between that of a vertical orientation and a horizontal orientation.

FIG. 3C is a side view of certain embodiments of a multi-platen press wherein the frame is in a horizontal orientation.

FIG. 4 is an exploded front perspective view of certain embodiments of a multi-platen press.

FIG. 5 is a perspective view of certain embodiments of a platen.

FIG. 6A is a front view of certain embodiments of a multi-platen press with the platens in an open configuration.

FIG. 6B is a front view of certain embodiments of a multi-platen press with the platens in a closed configuration.

FIG. 7 is a rear perspective view of certain embodiments of a multi-platen press.

FIG. 8 is a perspective view of certain embodiments of a cross-section of the first end of the frame.

FIG. 9 is a front perspective view of certain embodiments of a multi-platen press wherein the frame is in a horizontal orientation.

Like reference numerals refer to like parts throughout the several views of the drawings.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

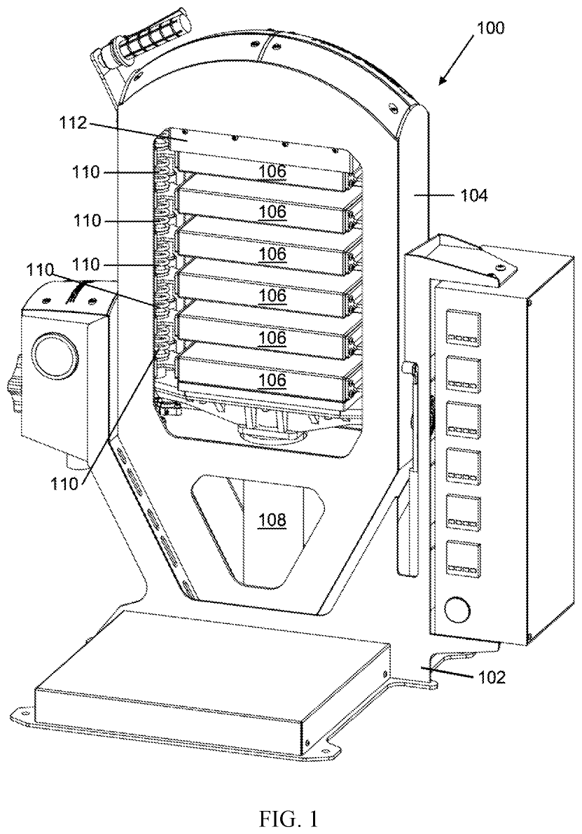

Certain embodiments of a multi-platen press 100, seen in FIG. 1, are configured for compressing materials and extracting fluids therefrom. Such embodiments comprise a stand 102, a frame 104, platens 106, a first linear actuator 108, springs 110, and a stationary structure 112.

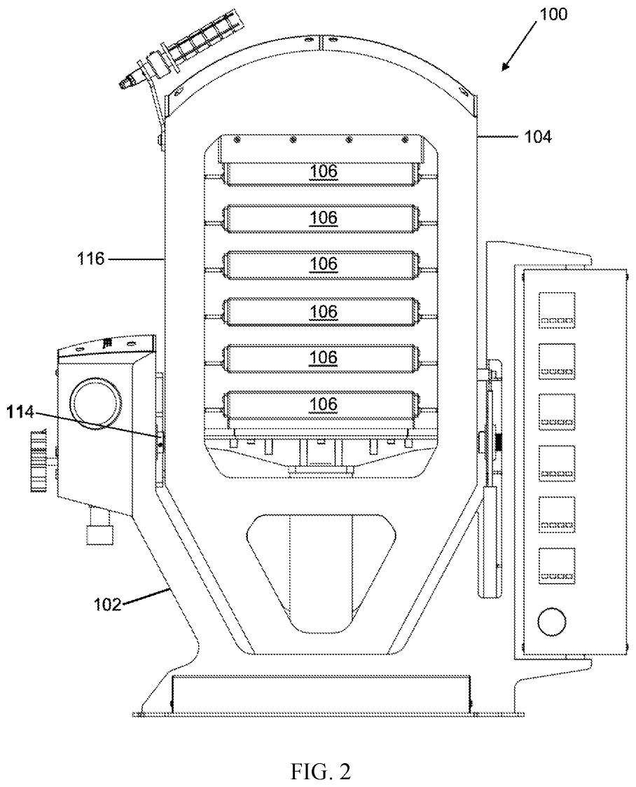

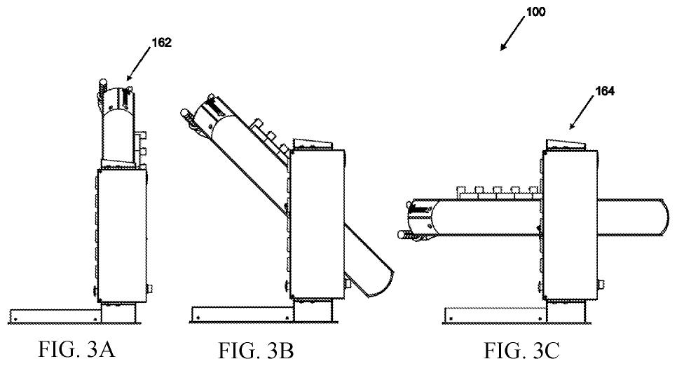

Certain embodiments, as seen in FIG. 2, comprise a frame 104 that comprises an open front aspect. The frame 104 comprises a first lateral side of the frame 116 that comprises a pivotal interconnection 114 with the stand 102 configured to allow the frame 104 to rotate in relation to the stand 102 about the pivotal interconnection 114. In certain embodiments the frame further comprises a second lateral side comprising a second pivotal interconnection with the stand. As seen in FIG. 3A, FIG. 3B, and FIG. 3C, the frame 104 is configured to pivotally rotate about the pivotal interconnection 114 between a vertical orientation 162 and a horizontal orientation 164, or at any orientation therebetween.

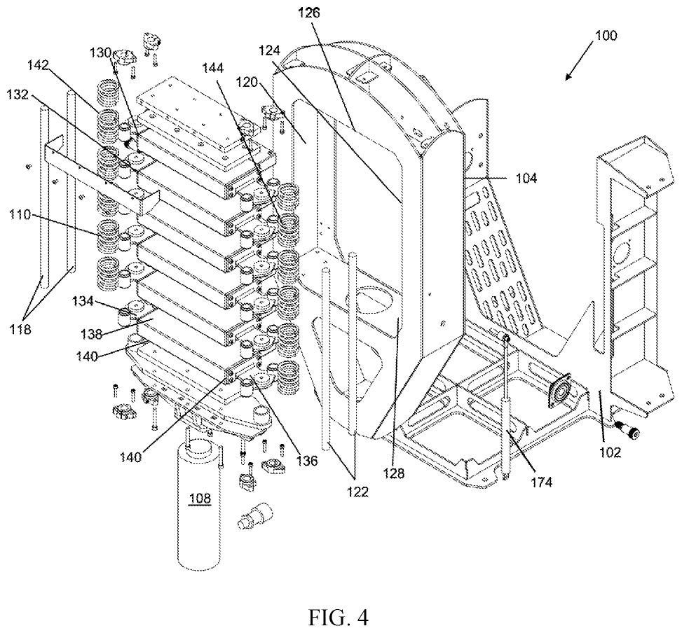

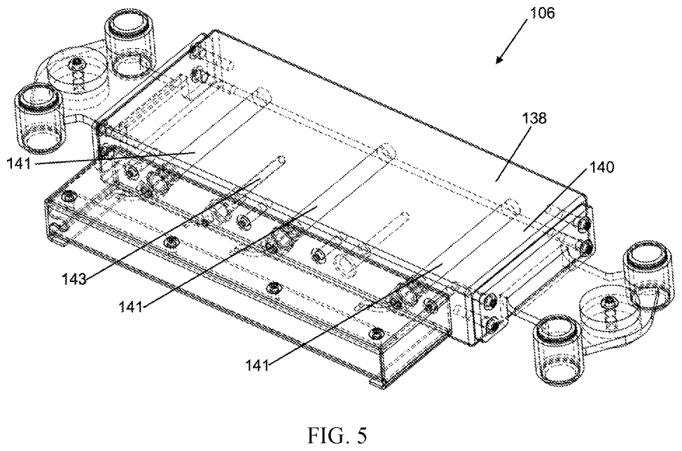

In certain embodiments, as seen in FIG. 4, the frame 104 comprises a first linear guide 118 interconnected to a first lateral aspect of the frame 120. The frame 104 comprises a second linear guide 122 interconnected to a second lateral aspect of the frame 124. In certain embodiments, the first linear guide 118 and the second linear guide 122 are oriented longitudinally between a first end of the frame 126 and a second end of the frame 128. Certain embodiments comprise platens 106 that comprise a first lateral aspect 134 slideably interconnected to the first lateral guide 118. The platens 106 comprise a second lateral aspect 136 slideably interconnected to the second lateral guide 122. In certain embodiments, the platens 106 are configured to slide along the first linear guide 118 and the second linear guide 122 via the first lateral aspect 134 and the second lateral aspect 136. Certain embodiments comprise platens 106 that comprise a first platen 130 and a second platen 132. The platens 106 comprise a first surface 138 oriented toward the first end of the frame 126 and a second surface 140 oriented toward the second end of the frame 128. The platens 106 are configured to receive material and compress material between the second surface 140 of the first platen 130 and the first surface 138 of the second platen 132. In some embodiments, as seen in FIG. 5, the platens 106 each comprise a heating element 141 that is adapted to heat each platen to a desired temperature. In certain embodiments, the platens 106 comprise a thermocouple 143 or alternate temperature measuring device. Referring back to FIG. 4, in certain embodiments, the springs 110 are positioned between each of the platens 106. Certain embodiments comprise a first spring 142 positioned between the first lateral aspect 134 of the first platen 130 and the first lateral aspect 134 of the second platen 132 and a second spring 144 positioned between the second lateral aspect 136 of the first platen 130 and the second lateral aspect 134 of the second platen 132. The springs 110 are configured to apply an expanding force between the first platen 130 and the second platen 132. The springs 110 are further configured to apply an expanding force between the platens 106.

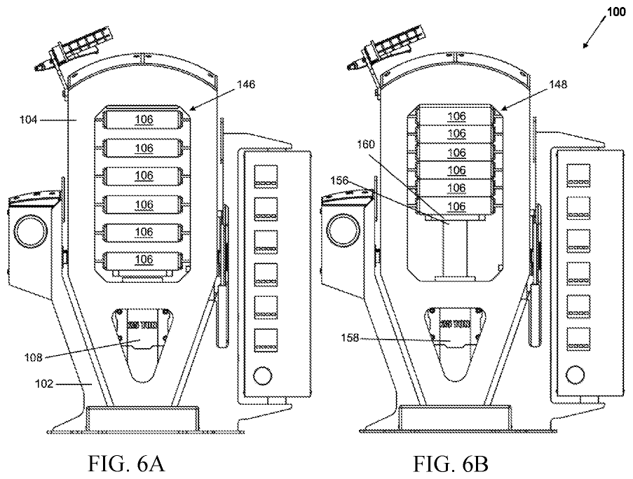

Certain embodiments, as seen in FIG. 6A and FIG. 6B, comprise a first linear actuator 108 interconnected within the frame 104. The first linear actuator 108 is configured to translate longitudinally within the frame 104 and translate the platens 106 toward the first end of the frame 126 and compress the second platen 132 toward the first platen 130. In certain embodiments, the first linear actuator 108 translates the platens 106 from an uncompressed or open configuration 146 to a compressed or closed configuration 148. In some embodiments, the first linear actuator 108 has a first end 156 that is configured to apply a force to the second surface 140 of the second platen 132 in the direction of the first end of the frame 126. In certain embodiments, the second end of the first linear actuator 158 is interconnected to the frame 126. In certain embodiments, the first end of the first linear actuator 156 comprises a top plate 160 adapted for distributing the applied force equally over the surface area of the second surface 140 of the second platen 132.

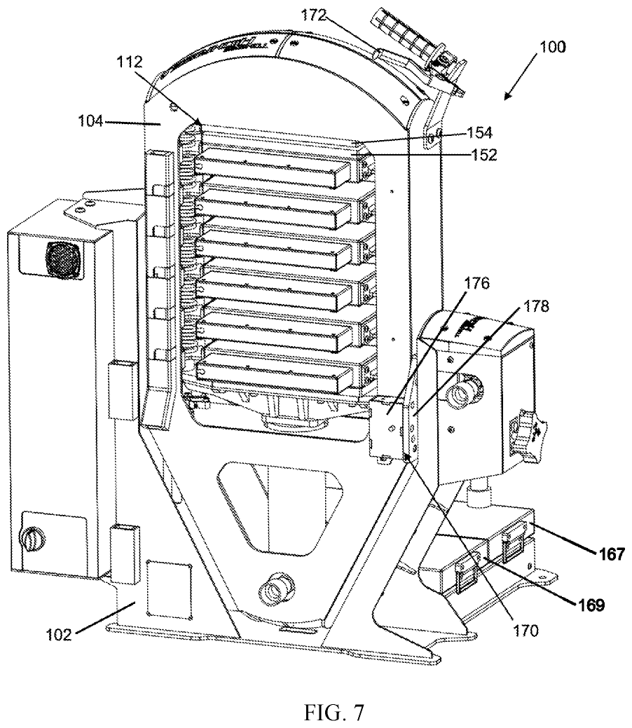

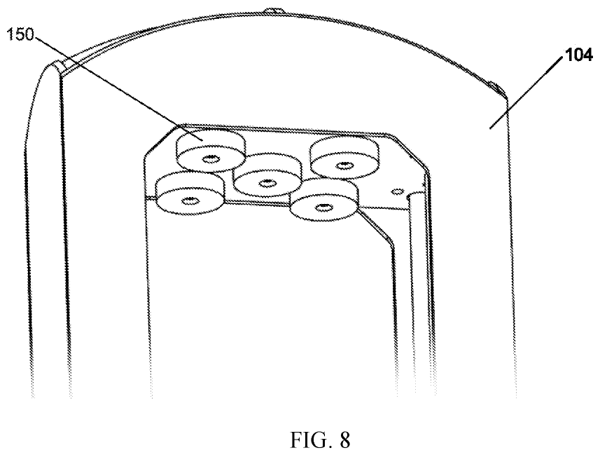

Certain embodiments, as seen in FIG. 7, comprise a stationary structure 112 interconnected within the frame 104 that is configured to arrest the translation of the first platen 130 toward the first end of the frame 126. In some embodiments, the stationary structure 112 is compressible. In some embodiments, the stationary structure 112 comprises a compressible bushing 150. In some embodiments, a first insulator plate 152 is interconnected to the first surface 138 of the first platen 130 and the stationary structure 112 is a second insulator plate 154, wherein the first insulator plate 152 is configured to abut the second insulator plate 154 when the platens 106 are translated toward the first end of the frame 126. In some embodiments, the first insulator plate 152 and the second insulator plate 154 are adapted for mitigating transfer of heat energy between the first platen 130 and the frame 104.

Certain embodiments are configured so the pivotal interconnection 114 is offset toward the second end of the frame 128 wherein the first end of the frame 126 extends horizontally outward in a first horizontal direction away from the pivotal interconnection 114 when the frame 104 is rotated away from the vertical orientation 162.

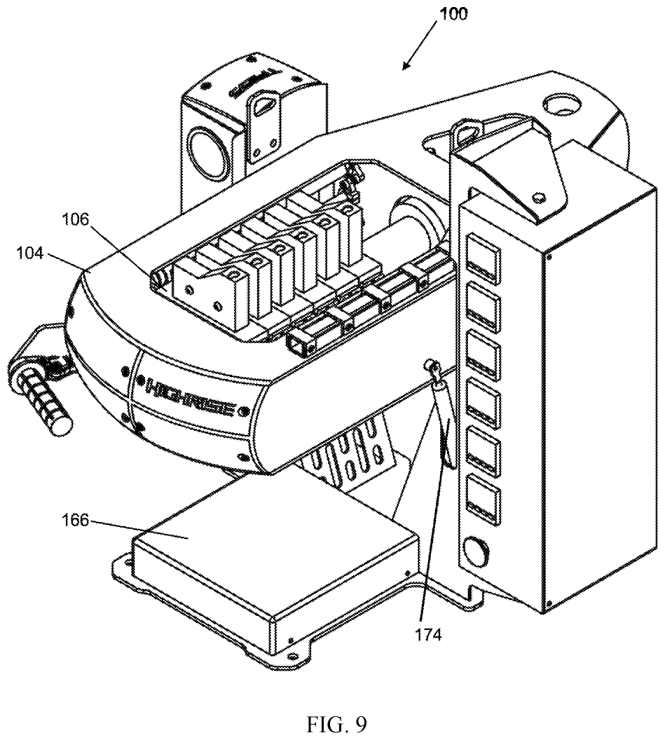

Certain embodiments, as seen in FIG. 9 comprise a collection plate 166. In certain embodiments, the collection plate extends outward in the first direction where the collection plate 166 is configured to lie vertically below the platens 106 when the frame 104 is moved away from a vertical orientation 162. In some embodiments, the collection plate 166 comprises a cooling element 168 adapted for cooling the collection plate 166 to a desired temperature. In some embodiments, the collection plate 166 comprises a first collection plate 167 and a second collection plate 169, as seen in FIG. 7.

Certain embodiments, referring back to FIG. 7, comprise a brake 170 interconnected between the stand 102 and the frame 104. The brake 170 is configured to restrict the rotation of the frame 104 in relation to the stand 102. The brake 170 comprises a brake release 172 interconnected with the brake 170 wherein when the brake release 172 is actuated, the brake release 172 results in allowing the rotation of the frame 104 in relation to the stand 102 about the pivotal interconnection 114. Further, when the brake release 172 is released, the brake release 172 results in restricting the rotation of the frame 104 in relation to the stand 102. In some embodiments, the brake 170 and brake release 172 comprise a mechanical locking pin mechanism 176 that upon the actuation of the brake release 172, mechanically releases a pin from a locked position within a brake plate 178 interconnected to the stand 102. In certain embodiments, the brake plate 178 comprises holes that are associated with various angles/orientations of the frame 104 between a vertical orientation 162 and a horizontal orientation 164, the holes of the brake plate 178 located at predetermined positions. Upon the release of the brake release 172, the pin is mechanically translated into one of the predetermined holes of the brake plate 178, restricting the rotation of the frame 104 in relation to the stand 102.

Certain embodiments comprise a rotational assist device 174 that is interconnected between the stand 102 and the frame 104. The rotational assist device 174 is adapted to provide counterbalancing support for rotating the frame 104 about the pivotal interconnection 114. The rotational assist device 174 of certain embodiments comprises a second linear actuator and further, a gas strut. Alternate embodiments wherein the rotational assist device comprises a rotary spring, a rotary motor, or other mechanical assist device are within the spirit and scope of the present invention.

In operation of certain embodiments, the frame 104 is in a vertical orientation 162 with the platens 106 in the open configuration 146. The platens 106 are heated to a predetermined temperature. Plant or plant material is placed between the platens 106. The first linear actuator 108 is engaged to apply a force to the platens 106, translating the platens 106 from the open configuration 146 to a closed configuration 148. As the platens 106 are translating to the closed configuration 148, the plant or plant material is compressed between the platens 106, wherein the operator actuates the brake release 172 of the brake 170 to pivotally rotate the frame 104 about the pivotal interconnection 114 of the stand 102. The operator chooses a predetermined rate and speed to pivotally rotate the frame from the vertical orientation 162 to a horizontal orientation 164, or at any orientation therebetween. The operator also chooses a predetermined pressure of the first linear actuator 108 to apply between the platens 106. During extraction, the fluids, rosin, and/or oils from the plant and/or plant materials flow from between the platens 106 and collect on the collection plate 166, wherein an operator can collect the fluids, rosin, and oils.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of,” and “consisting of” may be replaced with either of the other two terms. The invention illustratively described herein suitably may be practiced in the absence of any element or elements, limitation or limitations which is not specifically disclosed herein.

The terms “first,” second,” “top,” “bottom,” etc., as used herein, are intended for illustrative purposes only and do not limit the embodiments in any way. Additionally, the term “plurality,” as used herein, indicates any number greater than one, either disjunctively or conjunctively, as necessary, up to an infinite number. Further, “Providing” an article or apparatus, as used herein, refers broadly to making the article available or accessible for future actions to be performed on the article, and does not connote that the party providing the article has manufactured, produced, or supplied the article or that the party providing the article has ownership or control of the article.

One of ordinary skill in the art will appreciate the art within the drawings and can employ various alterations to the design within those presented. The drawings are exemplary of a design and are illustrative of the invention but should not be construed to create limitations of the invention. The invention in the drawings suitably may be practiced in variations without departure from the spirit of the invention.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. An apparatus for compressing materials and extracting fluids therefrom, comprising:
a stand;
a frame comprises an open front aspect;
the frame comprises a pivotal interconnection with the stand, wherein the first lateral side of the frame is pivotally interconnected with the stand, wherein the frame is configured to rotate in relation to the stand about the pivotal interconnection;
the frame further comprises a first linear guide interconnected to a first lateral aspect of the frame, and a second linear guide interconnected to a second lateral aspect of the frame, wherein the linear guides are longitudinally oriented between a first end of the frame and a second end of the frame;
a first platen and a second platen, the platens each comprise a first lateral aspect slidably interconnected to the first linear guide, and the platens each further comprise a second lateral aspect slidably interconnected to the second linear guide, wherein the platens are configured to slide along the linear guides;
the platens each comprise a first surface oriented toward the first end of the frame, and a second surface oriented toward the second end of the frame, wherein the second surface of the first platen and the first surface of the second platen are configured to compress a material placed therebetween;
the platens each further comprise a heating element adapted for heating each platen to a desired temperature;
a first spring positioned between the first lateral aspect of the first platen and the first lateral aspect of the second platen, and a second spring positioned between the second lateral aspect of the first platen and the second lateral aspect of the second platen, the springs are configured to apply an expanding force between the first platen and the second platen;
a first linear actuator interconnected to the frame configured to translate longitudinally within the frame and translate the platens toward the first end of the frame, and compress the second platen toward the first platen; and
a stationary structure interconnected within the frame, configured to arrest the translation of the first platen toward the first end of the frame.

2. The apparatus of claim 1, wherein the stationary structure is compressible.

3. The apparatus of claim 1, wherein the stationary structure comprises a compressible bushing.

4. The apparatus of claim 1, wherein a first end of the first linear actuator is configured to apply a force to the second surface of the second platen in the direction of the first end of the frame; and
a second end of the first linear actuator is interconnected to the frame.

5. The apparatus of claim 4, wherein the first end of the first linear actuator comprises a top plate adapted for distributing the applied force equally over the surface area of the second surface of the second platen.

6. The apparatus of claim 1, wherein the pivotal interconnection is offset toward the second end of the frame,
wherein the first end of the frame extends horizontally outward in a first horizontal direction away from the pivotal interconnection when the frame is rotated away from the vertical orientation.

7. The apparatus of claim 6, wherein the frame is configured to pivotally rotate between a between a vertical orientation and a horizontal orientation.

8. The apparatus of claim 6, wherein the apparatus further comprises a collection plate, wherein the collection plate extends outward in the first direction, and
wherein the collection plate is configured to lie vertically below the platens when the frame is moved away from a vertical orientation.

9. The apparatus of claim 8, wherein the collection plate further comprises a cooling element adapted for cooling the collection plate to a desired temperature.

10. The apparatus of claim 9, wherein the collection plate further comprises a first collection plate and a second collection plate.

11. The apparatus of claim 1 further comprising, a brake interconnected between the stand and the frame,
wherein the brake is configured to restrict the rotation of the frame in relation to the stand.

12. The apparatus of claim 11 further comprising a brake release interconnected with the brake,
wherein the actuation of the brake release results in allowing the rotation of the frame in relation to the stand about the pivotal interconnection, and
wherein the release of the brake release results in restricting the rotation of the frame in relation to the stand.

13. The apparatus of claim 1 further comprising a rotational assist device, wherein the rotational assist device is interconnected between the stand and the frame, and the rotational assist device is adapted to provide counterbalancing support for rotating the frame about the pivotal interconnection.

14. The apparatus of claim 13, wherein the rotational assist device comprises a second linear actuator.

15. The apparatus of claim 14, wherein the second linear actuator comprises a gas strut.

16. The apparatus of claim 1 further comprising a first insulator plate interconnected to the first surface of the first platen; and
the stationary structure comprises a second insulator plate,
wherein the first insulator plate is configured to abut the second insulator plate when the platens are translated toward the first end of the frame,
and wherein the insulator plates are adapted for mitigating transfer of heat energy between the first platen and the frame.

17. The apparatus of claim 1, wherein the platens each further comprise a temperature sensing device.
